(19) United States
(12) Patent Application Publication
(10) Pub. No.: US 2026/0360227 A1
(43) Pub. Date: Nov. 12, 2026

(54) Method for a Live Card Game Tournament Investment Platform

(71) Applicant: Vicky Shiraz Palombo, Las Vegas, NV (US)

(72) Inventor: Vicky Shiraz Palombo, Las Vegas, NV (US)

(21) Appl. No.: 19/205,321

(22) Filed: May 12, 2025

(51) Int. Cl. G07F 17/32

(52) U.S. Cl. CPC G07F 17/3293; G07F 17/3239; G07F 17/3276

(57) ABSTRACT

The present invention relates to a secure, automated method for investors to fund card tournament players, leveraging artificial intelligence (AI) and blockchain technology in an effort to enhance transparency, security, and investment outcomes. The platform enables players to sell a percentage of their winnings to multiple investors while maintaining a secure and transparent investment environment. AI algorithms analyze player performance data, providing insights into player success, which investors can use for informed decision-making. Blockchain technology is employed to track player performance and maintain a record of transactions, including real-time updates to player ratings and automated investor notifications. Secure scheduling and financial transaction handling ensures that player winnings are distributed directly to investors based on predefined terms, with a transparent fee structure managed through smart contracts. An object of the invention is to utilize AI, blockchain, and secure automated payments to create a robust ecosystem for player-investor interactions during poker tournaments.

### CROSS-REFERENCE TO RELATED APPLICATIONS

This application claims the benefit of U.S. Provisional Patent Application No. US19180426 titled ‘Big Pots Poker’ filed on Apr. 16, 2025.

### FIELD OF THE INVENTION

The present invention generally relates to the gaming industry. More specifically, it relates to a method of easily connecting card players with investors in an effort to enhance stakeholder relationships.

### BACKGROUND

Card game tournaments (such as poker etc.) have grown significantly in popularity, transforming from niche gatherings into mainstream, high-stakes events with millions of dollars in prizes. Professional and amateur players alike are drawn to these competitions, motivated by the potential for substantial winnings and the thrill of high-level play. However, the cost of participating in such tournaments can be prohibitive, particularly for skilled players who lack the financial resources to cover entry fees, travel expenses, and other associated costs. To overcome this financial barrier, many players seek external funding from investors, a practice commonly known as staking. Staking involves an agreement between a player and one or more investors, where the player receives financial backing for tournament entries in exchange for a share of any winnings. This arrangement is mutually beneficial when successful, as players gain access to tournaments they otherwise could not afford, and investors receive a return on their investment proportional to the player's performance. However, despite the apparent simplicity of this arrangement, staking is fraught with challenges that can undermine trust and lead to financial losses for both parties.

For players, the primary challenge lies in establishing credibility and securing reliable funding. Skilled players may struggle to demonstrate their abilities to potential investors, particularly if they are new to the tournament scene or lack a well-documented history of winnings. Even experienced players can find it difficult to connect with trustworthy investors in a crowded and competitive market. Without a centralized platform to showcase their skills and tournament history, players must rely on personal networks, social media, or unregulated online forums, all of which lack transparency and accountability. In these environments, misrepresentation of player skills or results is a common risk, and players may face difficulties in obtaining consistent funding from reputable backers. Investors, on the other hand, face the opposite problem. They must identify skilled and trustworthy players capable of delivering a return on investment. However, without access to verifiable data on player performance, investors are forced to rely on personal judgments, word of mouth, or self-reported results from players, all of which can be misleading or inaccurate. Even if a player appears promising, the absence of a secure, standardized process for managing investments and distributing winnings exposes investors to significant risks. Disputes may arise if players fail to honor their commitment to share winnings or if there are disagreements over payout calculations.

Moreover, the traditional methods of managing staking arrangements are inefficient and prone to errors. Payments are often handled manually, with players and investors exchanging funds through peer-to-peer transfers, which are time-consuming and lack security. Investors must trust that players will accurately report their tournament results and share winnings as promised, but without a trusted third party to verify outcomes and enforce agreements, this trust is easily broken. In some cases, players may intentionally misrepresent their results, withhold winnings, or fail to repay investors, leading to financial losses and damaged reputations. The limitations of existing staking practices are further compounded by the absence of effective dispute resolution mechanisms. When disagreements arise over payout distribution, there is no centralized authority to mediate conflicts, leaving players and investors to resolve disputes independently. This lack of accountability is a deterrent for many potential investors who may be interested in staking players but are unwilling to accept the risks associated with unregulated, informal arrangements.

A review of the existing patent landscape reveals that while some prior art acknowledges player-investor interactions in gaming contexts, none provide a comprehensive solution to the specific challenges of poker tournament staking. For instance, U.S. Pat. No. 8,128,472 describes a system for intra-tournament stake-sharing among players at a final table, but it does not address external investment by third-party backers. Similarly, U.S. Pat. No. 9,245,413 focuses on converting poker chips into stored value payment vehicles but lacks any mechanism for external investors to fund player participation. U.S. Pat. Nos. 9,649,564 and 8,414,387 describe peer-to-peer wagering systems, where individuals can bet against each other, but these systems do not offer a structured model for staking players in poker tournaments. Existing staking platforms, where they exist, are typically fragmented, unregulated, and lack the technological sophistication needed to ensure transparency, security, and accountability. Most rely on manual processes, which are vulnerable to manipulation and fraud, or operate in isolated online forums where investors have little to no protection against dishonest players. These limitations prevent players from accessing consistent funding and deter investors from participating due to the high risk of loss. The absence of a secure, transparent, and scalable system for managing staking arrangements in poker tournaments demonstrates a clear need for an improved solution that can protect both players and investors, enhance trust, and streamline the investment process.

### SUMMARY OF THE INVENTION

The device herein disclosed and described provides a solution to the shortcomings in the prior art through the disclosure of a carrier controller brokerage. An object of the present invention is to provide a secure and transparent platform for poker tournament staking, enabling players to sell a percentage of their tournament entries to multiple investors. This allows players who may not have sufficient funds to participate in high-stakes tournaments to access funding, while investors can diversify their investments across multiple players, reducing their overall risk.

Another object of the invention is to offer a reliable and automated payment processing system that ensures investors receive their share of player winnings directly and without delay. By integrating direct payouts from the casino to the platform's secure merchant account, the system prevents disputes and eliminates the risk of players failing to honor their financial commitments to investors.

An additional object of the invention is to incorporate artificial intelligence algorithms to analyze player performance data and provide predictive insights. These AI algorithms can evaluate a player's historical performance, current form, and other relevant metrics, offering investors a data-driven assessment of each player's potential profitability. This empowers investors to make informed decisions and minimizes the risks associated with staking players of unknown skill.

Another object of the invention is to use blockchain technology to ensure the transparency and security of all staking transactions and player performance records. Blockchain provides a decentralized, tamper-resistant ledger where each transaction, including player investments, winnings distribution, and performance updates, is securely recorded. This prevents manipulation of data and ensures that both players and investors have access to a trusted record of their interactions.

A further object of the invention is to establish a player verification and identity management system, ensuring that only authenticated players can list their profiles and request investments. This system helps prevent fraud by confirming the identity of players and maintaining accurate player histories, which are visible to potential investors for their due diligence.

Another object of the invention is to offer real-time updates to investors on player performance during tournaments, allowing them to track their investments and receive notifications when a player they have backed achieves a winning result. These notifications are enabled by a blockchain-based smart contract system, which automatically updates player ratings and triggers investor notifications without manual intervention. This feature also includes a scheduling platform wherein investors can view and scroll through multiple players' allotted play time and select a player they want to support quickly.

Another object of the invention is to provide an investor dashboard where users can view their active investments, historical performance of players they have backed, and detailed analytics generated by the platform's artificial intelligence system. This dashboard offers a clear, user-friendly interface for managing and evaluating investments.

Another additional object of the invention is to implement a secure, escrow-style payout structure where tournament winnings are distributed automatically through smart contracts. This ensures that investors receive their share of winnings based on the agreed terms, while the platform retains a service fee as compensation for its operational costs. Such a system eliminates the need for manual payout calculations and minimizes the risk of disputes.

Another object of the invention is to offer a subscription model for players seeking enhanced exposure to investors. Players can choose to upgrade to a premium plan, which provides additional visibility within the platform, access to a larger network of investors, and advanced analytics on their performance. This subscription model allows the platform to generate consistent revenue while providing players with greater opportunities to secure funding.

A further object of the invention is to provide investors with curated recommendations based on player performance data, leveraging artificial intelligence to suggest players who are most likely to achieve positive outcomes. This recommendation engine simplifies the investment decision process for investors, particularly those who are new to poker staking.

Another object of the invention is to maintain a public leaderboard that ranks players based on their recent tournament results, total winnings, and average return on investment. This leaderboard offers transparency and competitive motivation for players, while providing investors with a quick reference for identifying top-performing players.

Another object of the invention is to ensure compliance with financial regulations by implementing secure payment processing protocols and user identity verification. This reduces the risk of regulatory violations and ensures that the platform can operate legally in multiple jurisdictions.

Finally, an object of the invention is to create a trustworthy ecosystem where both players and investors can engage in staking arrangements with confidence, knowing that their interactions are protected by advanced security measures, transparent data management, and automated payout processing. This system transforms traditional staking into a scalable, reliable, and secure investment model.

It is briefly noted that upon a reading this disclosure, those skilled in the art will recognize various means for carrying out these intended features of the invention. As such it is to be understood that other methods, applications and systems adapted to the task may be configured to carry out these features and are therefore considered to be within the scope and intent of the present invention, and are anticipated. With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention. As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present.

By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements. The objects features, and advantages of the present invention, as well as the advantages thereof over existing prior art, which will become apparent from the description to follow, are accomplished by the improvements described in this specification and hereinafter described in the following detailed description which fully discloses the invention, but should not be considered as placing limitations thereon.

### BRIEF DESCRIPTION OF THE FIGURES

The accompanying drawings, which are incorporated herein and form a part of the specification, illustrate some, but not the only or exclusive, examples of embodiments and/or features.

FIG. 1 shows a perspective view of the system being utilized.

FIG. 2 shows a representative view of the system's network.

FIG. 3 shows a representative view of the block chain operations.

FIG. 4 shows a representative view of the method.

FIG. 5 shows a view of the system's scheduling feature.

Other aspects of the present invention shall be more readily understood when considered in conjunction with the accompanying drawings, and the following detailed description, neither of which should be considered limiting.

### DETAILED DESCRIPTION OF FIGURES

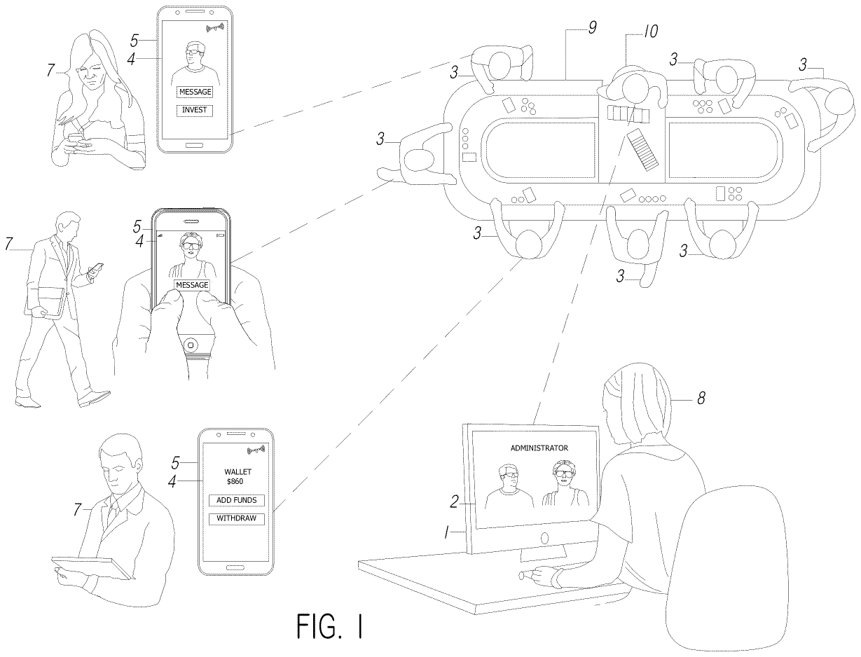

In this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation. Conventional components of the invention are elements that are well-known in the prior art and will not be discussed in detail for this disclosure. The present invention is a sophisticated, secure, and automated card-playing tournament staking platform meticulously designed to operate seamlessly on a plurality of computing devices including but not limited to: mobile devices 5; desktop computers 11; laptops 12; smartphones 14; and tablets 13 etc. (as shown in FIG. s 1 and 2) through dedicated applications such as Windows, Mac, iOS and Android etc. This platform 2 and 4 as depicted in FIG. 1 is powered by a highly advanced cloud-based infrastructure 21 that ensures high availability, scalability, and security for users worldwide. By integrating a range of cutting-edge technologies, including artificial intelligence (AI), blockchain, biometric security, advanced encryption, real-time analytics, and secure payment processing 25, the platform provides a reliable, user-friendly environment for players seeking financial backing and investors as shown in FIG. 1 aiming to fund skilled players 3 in exchange for a share of potential winnings. The combination of mobile accessibility, cloud computing, and sophisticated technology creates a transformative system that enhances the transparency, security, and efficiency of traditional poker staking.

The platform is built on a secure, cloud-native architecture hosted on industry-leading cloud service providers such as Amazon Web Services, Microsoft Azure and Google Cloud Platform etc. This cloud infrastructure utilizes a microservices architecture, where each functional component—such as user authentication, player performance analytics, transaction management, and payout processing—is developed and deployed as an independent, scalable service. This design ensures that the platform can efficiently scale to support thousands of concurrent users without performance degradation. Cloud-based load balancers intelligently distribute user requests across multiple server instances, ensuring high availability and rapid response times. To enhance reliability, the platform employs containerization technology using Docker and Kubernetes. Each microservice is packaged into a container, allowing for consistent deployment across cloud environments and efficient resource management. Kubernetes orchestrates these containers, automatically scaling them up or down based on user demand. Redundancy is ensured through multi-region cloud deployment, with automated failover mechanisms and real-time data replication, ensuring that the platform remains operational even in the event of a regional server failure. Data security is a top priority. All user data, including financial transactions and performance records, is encrypted both in transit and at rest using advanced encryption algorithms, such as AES-256 and TLS 1.3. Sensitive data, such as identification documents and biometric information, is securely stored using cloud-based, historical data vaults 26 with role-based access control, ensuring that only authorized systems can access this information. The mobile applications, available on iOS and Android, are developed using a hybrid development framework like React Native or Flutter. This approach ensures consistent functionality and user experience across both platforms while minimizing development and maintenance costs. The mobile app interface is designed with user experience in mind, providing a clean, intuitive layout with easy navigation. Security is enhanced with biometric authentication (fingerprint or facial recognition) for fast and secure user login, combined with multi-factor authentication (MFA) for added protection against unauthorized access.

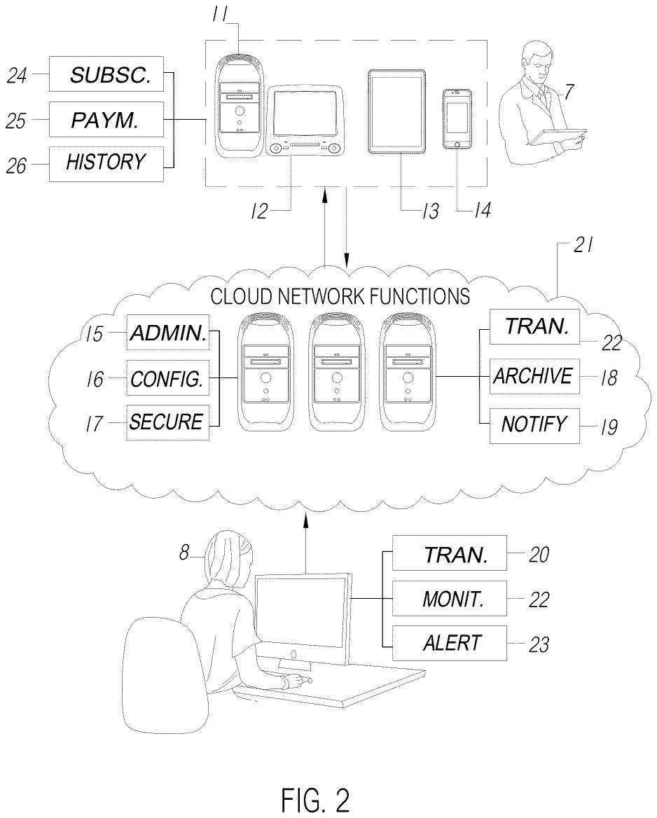

The platform employs a secured, multi-layered user authentication and identity verification process 17 to ensure that only legitimate users can participate. During account creation, players are required to complete identity verification using a combination of methods. This includes submitting government-issued identification (such as a driver's license, passport, or national ID card), providing a verified bank account for receiving payouts, and completing biometric verification using the device's camera for facial recognition. The biometric verification process uses liveness detection technology to prevent spoofing attempts with photographs or video recordings. Identity verification is powered by an advanced Know Your Customer (KYC) service, which uses artificial intelligence to automatically verify the authenticity of submitted documents. This AI-powered verification system can detect forged or altered identification documents in real-time, reducing the risk of identity fraud. The KYC service also cross-references user information against global watchlists and fraud prevention databases, ensuring compliance with financial regulations and preventing the platform from being used for money laundering or other illegal activities. Investors are also required to complete identity verification before they can participate. This process is similar to player verification, including document submission, biometric authentication, and bank account verification. Verified users are granted access to the platform's staking marketplace, where they can securely engage in player investments. FIG. 2 showing a representative view of the system operations that includes but are not limited to: a cloud network 21 with administrative features 15 (subscriber demographics and accounts); player and investor configurations 16 (rankings and reputation scores etc.); security measures (WEPS, etc.); transactions 22 (games played, outcomes etc.); archives 18 (storage of all transactions from all stakeholders); notifications to stakeholders 19 via email, SMS, voice etc.). Said cloud network 21 being connected to inventors 7 and allowing them to contribute to a subscription service 24; forward and receive payments 25 (via direct bank handshaking, Venmo, PayPal etc.); and having access to historical activities (player game history, reputation scores, etc.). Administrators 8 and players 3 having access to all transactions between all stakeholders 20; monitoring all gameplay 22 both locally and remotely; and receiving notifications or alerts 23 from investors by means of cloud network 21.

A central feature of the platform is its artificial intelligence (AI) engine, which continuously analyzes player performance data to provide investors with data-driven insights. This AI engine is powered by a combination of advanced machine learning algorithms, including neural networks, decision trees, and reinforcement learning models. These algorithms are trained on extensive datasets of historical tournament results, player win rates, average return on investment (ROI), finishing positions, and other critical performance metrics. The AI system is designed to ingest both historical and real-time data, enabling it to maintain up-to-date player profiles as new tournament results are recorded. For each player, the AI engine generates a comprehensive performance profile, which includes but is not limited to: Win Probability Calculations (predicts the likelihood of a player achieving a winning result in future tournaments); Projected Earning (estimates potential winnings for a player based on historical performance and current form); Risk Assessments (categorizes players as low, medium, or high risk based on performance volatility); Trend Analysis (identifies players who are improving rapidly, experiencing winning streaks, or showing declining performance); and Comparative Analytics: Compares player performance against peer groups or tournament categories. These insights are presented to investors in a user-friendly format, allowing them to make informed decisions when selecting players to back. Investors can filter players based on specific criteria, such as high ROI, low risk, or strong recent performance.

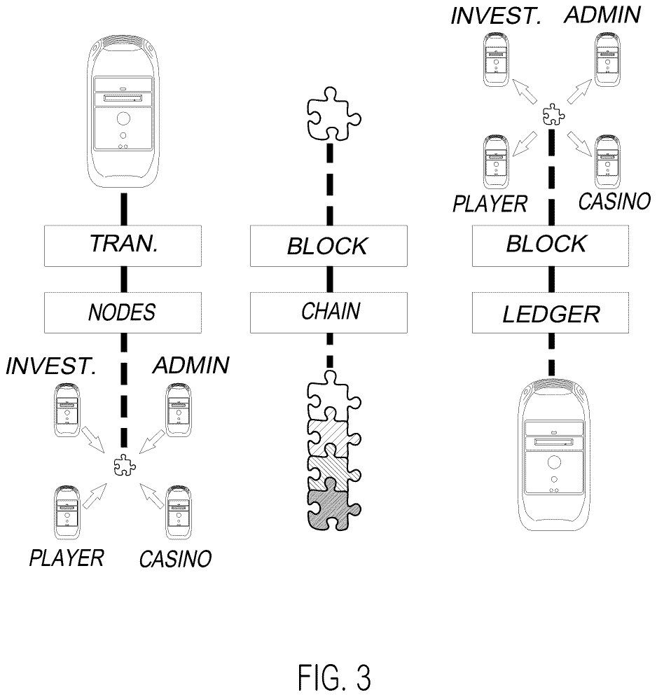

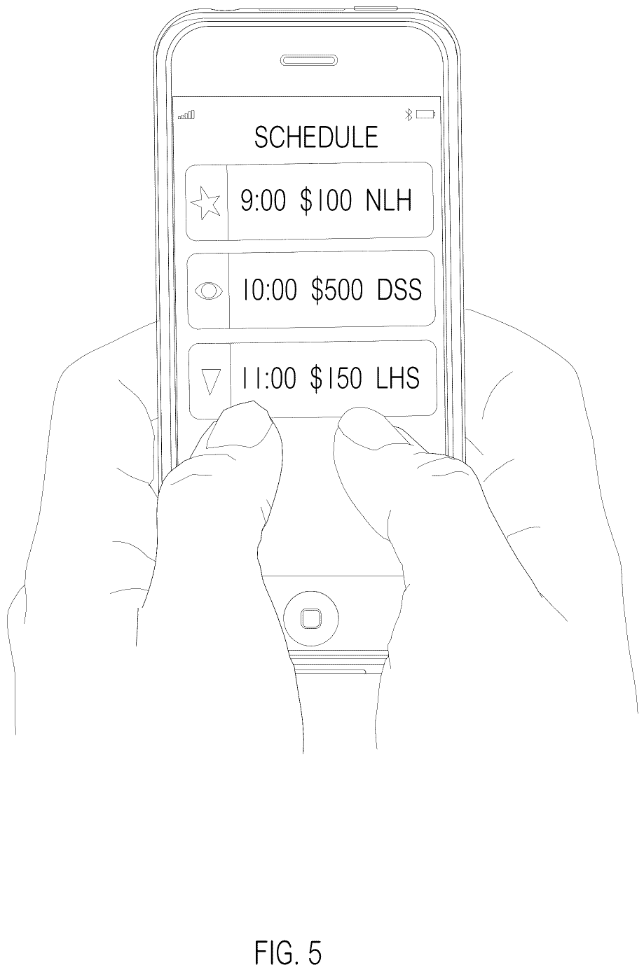

To ensure transparency and security, the platform employs a blockchain-based transaction management system as shown in FIG. 3 whereby stakeholders (investors, players, administration, and a casino etc.) are given access This blockchain ledger is implemented using a hybrid model, combining the security of a public blockchain (such as Ethereum) for transaction verification with the efficiency of a private blockchain for internal data processing. Each investment, tournament result, and payout distribution is recorded as an immutable, tamper-proof block on the blockchain. These records are accessible to players and investors, providing a transparent history of all financial interactions. Smart contracts are a core feature of the blockchain module. These automated contracts are used to enforce payout distribution terms. When a player wins a prize, the platform's blockchain smart contract calculates the distribution of winnings, deducts the platform's service fee, and automatically transfers funds to each investor's digital wallet. This process is secure, transparent, and eliminates the risk of payout disputes. FIG. 5 showing a view of the system's schedule for players. Investors can scroll through a multitude of players, observer their time slot for play and amounts etc. so they can make informed decisions quickly.

The platform integrates a secure payment processing 25 module that supports multiple payment methods, including credit cards, digital wallets (Apple Pay, Google Pay, PayPal), bank transfers, and cryptocurrencies (such as Bitcoin, Ethereum, or stablecoins). Payments are processed through a PCI-DSS-compliant payment gateway, ensuring that all financial data is encrypted and securely transmitted. Players list their tournament entries on the platform, specifying the percentage of their entry fee they wish to sell to investors. Funds from investors are securely held in an escrow account until tournament results are confirmed. When a player wins a prize, the tournament organizer transfers winnings to the platform's secure merchant account. The blockchain smart contract system then automatically calculates and distributes winnings to investors, while the platform retains a service fee. Investors receive their earnings directly in their digital wallets or bank accounts, ensuring fast and accurate payout processing.

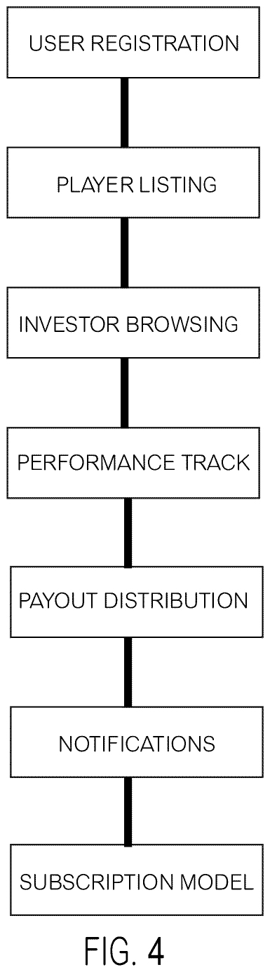

The platform also offers a premium subscription 24 model for players seeking enhanced visibility. Premium subscribers are highlighted in the player directory, receive enhanced exposure to investors, and gain access to advanced AI analytics. Premium players can also list an unlimited number of tournament entries, providing greater opportunities to secure funding. While the platform is designed for poker tournament staking, it can be easily adapted to support other competitive gaming formats, such as esports tournaments, fantasy sports leagues, chess competitions, or skill-based gaming events. In these scenarios, the AI engine is reconfigured to analyze performance data relevant to each game type, while the blockchain and smart contract system provide secure, transparent investment management. The present invention operates through a sophisticated, secure, and automated process designed to facilitate seamless player-investor interactions for poker tournament staking. This method is depicted in FIG. 4 and begins with user registration and identity verification, ensuring that all participants are properly authenticated before engaging with the platform. Users access the platform through a mobile application available on iOS and Android, which is securely connected to a cloud-based infrastructure. Upon downloading the app, users are prompted to create an account, selecting their role as either a “Player” or an “Investor.” Players are listed as those seeking financial backing for tournament entries, while investors provide funds in exchange for a share of any potential winnings.

For players, the registration process includes a comprehensive identity verification stage. Players must submit a government-issued identification document, such as a driver's license, passport, or national ID card. The platform employs advanced artificial intelligence-powered document recognition technology to automatically verify the authenticity of these submitted IDs, detecting any signs of forgery or alteration. Players are also required to provide a clear, high-resolution selfie for biometric verification using the device's front camera. This biometric verification employs liveness detection technology, ensuring that the user is physically present and preventing spoofing attempts with photographs or video recordings. Additionally, players must provide a verified bank account for receiving tournament winnings, ensuring secure and direct payout distribution. The platform's identity verification system cross-references user data against global fraud prevention databases, including anti-money laundering (AML) watchlists, ensuring compliance with financial regulations.

Investors undergo a similar identity verification process, which begins with submitting government-issued identification and completing biometric authentication. Investors must also provide a verified payment method, such as a credit card, digital wallet (Apple Pay, Google Pay, PayPal), or cryptocurrency wallet, which they will use to fund player investments. To receive payouts, investors are required to link a verified bank account or digital wallet address. These verification measures ensure that all participants—both players and investors—are legitimate and protect against fraud or unauthorized access. Once registered and verified, players can list their upcoming tournament entries on the platform. Each listing requires players to provide essential details, including the tournament name, location, date, and entry fee. Players specify the percentage of their entry fee they wish to sell to investors, which can range from as little as 5% to as much as 100%. Players can also customize their listings with a personal profile description, highlighting their experience, skills, and competitive history. To further support their listing, the platform's artificial intelligence (AI) engine automatically generates player performance analytics, which are displayed directly on the listing page. These analytics include historical win rates, total tournaments played, average return on investment (ROI), and recent performance trends. The AI engine continuously updates these analytics in real-time as players participate in new tournaments, providing investors with the most current data.

The AI-powered performance analysis also categorizes players by risk level, such as low, medium, or high risk, based on historical performance volatility. Players demonstrating consistent success are flagged as “high-potential players,” while those with volatile results may be identified as higher-risk investments. Players can further customize their staking terms, choosing to offer different payout percentages to early investors as an incentive, or providing performance bonuses for investors if they achieve top finishes in tournaments. Investors use the platform's mobile app to browse active player listings by browsing, which are presented in a directory with advanced filtering options. Investors can sort listings by player performance metrics, such as high average ROI, consistent win rates, or low-risk classification. They can also filter by tournament type, player experience, or specific regions. Each listing includes a detailed player profile with AI-generated analytics, giving investors a clear view of player performance, historical results, and projected earnings. Investors can view player performance graphs, highlighting win trends, earnings over time, and recent tournament outcomes. When an investor identifies a player they wish to back, they can purchase shares of the player's tournament entry directly through the mobile app. Payments are processed securely through a PCI-DSS compliant payment gateway, supporting a wide range of payout methods, including credit cards, digital wallets, and cryptocurrencies. Investors can specify the amount they wish to invest, and their funds are securely held in an escrow account until the tournament results are confirmed. The blockchain-based transaction management system records each investment as an immutable, tamper-proof transaction, ensuring transparency and protecting against fraud.

As players participate in tournaments, the AI engine continuously monitors their performance, updating player profiles with real-time results and notifies investors of progress. The blockchain ledger records each tournament outcome, providing a transparent and verifiable record of player performance. If a player achieves a winning result, the tournament organizer transfers the winnings directly to the platform's secure merchant account. The platform's blockchain-based smart contract system automatically calculates payout distributions, deducts the platform's service fee, and transfers the appropriate shares to each investor. This automated process eliminates the need for manual calculations and ensures that investors receive their earnings without delay. Investors receive real-time notifications whenever players they have backed achieve winning results. These notifications include detailed payout summaries, allowing investors to track their investment performance and view their earnings. Investors can withdraw their funds directly through the mobile app, choosing to transfer earnings to their linked bank account, digital wallet, or cryptocurrency wallet. The stakeholders also have the option of updating their subscription models at this time.

The platform also offers an enhanced subscription model 24 for players seeking greater exposure. Premium subscribers are highlighted in the player directory, receiving enhanced visibility to potential investors. These premium players gain access to advanced AI analytics, including personalized performance improvement insights and competitive benchmarking against similar players. Premium players can list an unlimited number of tournament entries, providing greater opportunities to secure funding.

In an alternative embodiments, the platform can be adapted to support other competitive gaming formats beyond poker tournaments. This includes esports competitions, fantasy sports leagues, chess tournaments, and other skill-based gaming environments. In these scenarios, the AI engine is customized to analyze performance data relevant to the specific game type, while the blockchain and smart contract system ensure secure, transparent investment management. The platform's sophisticated cloud-based architecture ensures high availability, scalability, and data security. Containerization technology using Docker and Kubernetes enables efficient management of platform services, automatically scaling them to accommodate user demand. Advanced encryption protocols protect user data, including financial transactions, biometric information, and player performance records. The platform's cloud infrastructure also includes automated data backups, disaster recovery capabilities, and multi-region deployment for global accessibility.

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

It is additionally noted and anticipated that although the device is shown in its most simple form, various components and aspects of the device may be differently shaped or slightly modified when forming the invention herein. As such those skilled in the art will appreciate the descriptions and depictions set forth in this disclosure or merely meant to portray examples of preferred modes within the overall scope and intent of the invention, and are not to be considered limiting in any manner. While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the scope of the invention.

What is claimed is:

1. A system for automated poker tournament staking and investment management, comprising:
a) a cloud-based server network configured to host a secure, scalable application accessible via mobile devices running iOS or Android operating systems, wherein the application is configured to facilitate interactions between players seeking financial backing for poker tournaments and investors providing funding;
b) a player authentication module configured to verify player identities using government-issued identification, biometric authentication, and secure Know Your Customer (KYC) verification protocols, wherein verified players are authorized to list tournament entries for investment;
c) an investor authentication module configured to verify investor identities using government-issued identification, biometric authentication, and secure KYC verification protocols, wherein verified investors are authorized to fund player tournament entries;
d) a player listing module configured to allow verified players to list tournament entries, specifying the tournament name, location, entry fee, and the percentage of the entry fee available for investment, wherein each listing is associated with player performance analytics generated by an artificial intelligence engine;
e) an artificial intelligence engine configured to continuously analyze player performance data, including historical tournament results, average return on investment, win rates, and other performance metrics, and to generate predictive insights for investors based on these metrics;
f) a blockchain transaction management module configured to securely record all financial transactions, including player investments, tournament results, and payout distributions, on a decentralized blockchain ledger, wherein each transaction is recorded as an immutable, tamper-proof record;
g) a secure payment processing module configured to process financial transactions using multiple payment methods, including credit cards, digital wallets, and cryptocurrencies, wherein funds from investors are securely held in an escrow account until tournament results are finalized;
h) a smart contract module configured to automatically calculate payout distributions for investors based on pre-agreed terms when a player achieves a winning result, wherein the smart contract distributes funds to investors and retains a platform service fee; and
i) a player and investor notification module configured to provide real-time notifications to investors when players they have backed achieve winning results, wherein notifications include payout details and performance updates.

2. A non-transitory computer-readable medium storing instructions that, when executed by one or more processors, cause a computing system to perform a method for automated poker tournament staking and investment management, the method comprising:
a) receiving a request from a verified player to list a tournament entry for investment, wherein the request includes tournament details, entry fee, and the percentage of the entry fee available for investment;
b) verifying the identity of the player using government-issued identification, biometric authentication, and secure Know Your Customer (KYC) verification protocols, wherein only verified players are authorized to list tournament entries;
c) receiving a request from a verified investor to purchase a percentage of the player's tournament entry, wherein the investor is authenticated using government-issued identification, biometric authentication, and KYC verification protocols;
d) analyzing player performance data using an artificial intelligence engine, wherein the artificial intelligence engine generates player performance analytics, including historical win rates, average return on investment, risk assessments, and predictive insights;
e) recording each investment transaction on a blockchain ledger, wherein the blockchain ledger securely records player investments, tournament results, and payout distributions as immutable, tamper-proof records;
f) monitoring the player's performance in the tournament in real-time, updating player profiles with the tournament results, and calculating payouts based on the player's final position;
g) distributing winnings using a smart contract, wherein the smart contract automatically calculates the payout distribution for each investor based on pre-agreed terms and transfers funds directly to investor accounts, while retaining a platform service fee;
h) providing real-time notifications to investors, wherein investors are notified of player performance updates and payout distributions through the mobile application; and
i) Allowing investors to withdraw their earnings through secure payment methods, including bank transfers, digital wallets, or cryptocurrency transactions.
The system of claim 1, wherein the artificial intelligence engine is further configured to generate player risk classifications, categorizing players as low, medium, or high risk based on historical performance volatility.

3. The system of claim 1, wherein the blockchain transaction management module uses a hybrid blockchain model, combining a public blockchain for transaction verification with a private blockchain for internal data processing.

4. The system of claim 1, wherein the player listing module further allows players to specify custom staking terms, including performance bonuses for investors based on player finishing position.

5. The system of claim 1, wherein the secure payment processing module is PCI-DSS compliant, ensuring secure transmission and storage of financial data.

6. The system of claim 1, wherein the player and investor notification module is configured to provide investors with predictive player insights generated by the artificial intelligence engine prior to making an investment decision.

7. The system of claim 1, wherein the smart contract module is further configured to dynamically adjust payout distribution terms based on player performance conditions specified in the listing.

8. The non-transitory computer-readable medium of claim 2, wherein the instructions further cause the computing system to calculate player win probabilities using a neural network model within the artificial intelligence engine.

9. The non-transitory computer-readable medium of claim 2, wherein the instructions further cause the computing system to automatically update player performance profiles in real-time as tournament results are received.

10. The non-transitory computer-readable medium of claim 2, wherein the instructions further cause the computing system to provide investors with a risk assessment for each player based on performance volatility.

11. The non-transitory computer-readable medium of claim 2, wherein the instructions further cause the computing system to allow players to create variable payout structures, specifying different percentages of winnings for early investors.

12. The non-transitory computer-readable medium of claim 2, wherein the instructions further cause the computing system to support multi-currency payments, including credit cards, digital wallets, and cryptocurrency transactions.

13. The non-transitory computer-readable medium of claim 2, wherein the instructions further cause the computing system to provide premium players with enhanced visibility to investors, including advanced performance analytics and leaderboard placement.

14. The non-transitory computer-readable medium of claim 2, wherein the instructions further cause the computing system to allow investors to configure custom notifications, selecting player categories, tournament types, and performance thresholds for receiving updates.

15. The non-transitory computer-readable medium of claim 2, wherein the instructions further cause the computing system to support a scheduling feature whereby investors can view a player's time slot for play.
